(19) United States
(12) Patent Application Publication
(10) Pub. No.: US 2005/0092288 A1
(43) Pub. Date: May 5, 2005

(54) Spider Jet for Intake Manifolds

(75) Inventor: Barron Parks, Broadview, MT (US)

Correspondence Address: BARRON PARKS, 16638 DONALD AVE, BROADVIEW, MT, 59015, US

(73) Assignee: Barron Parks, Broadview, MT (US)

(21) Appl. No.: 10/605,839

(22) Filed: Oct. 30, 2003

(51) Int. Cl. F02B 31/00

(52) U.S. Cl. 123/306

(57) ABSTRACT

The Spider Jet is an air redistribution system that can be fit on the intake manifold on any internal combustion engine. The Spider Jet is unique because it does not force additional air into the manifold, but rather redistributes the air already in the manifold to a more strategic location, which creates a better fuel to air mixture for the engine to consume. The better fuel to air mixture improves the horsepower of the engine, but also greatly improves the fuel efficiency of the engine.

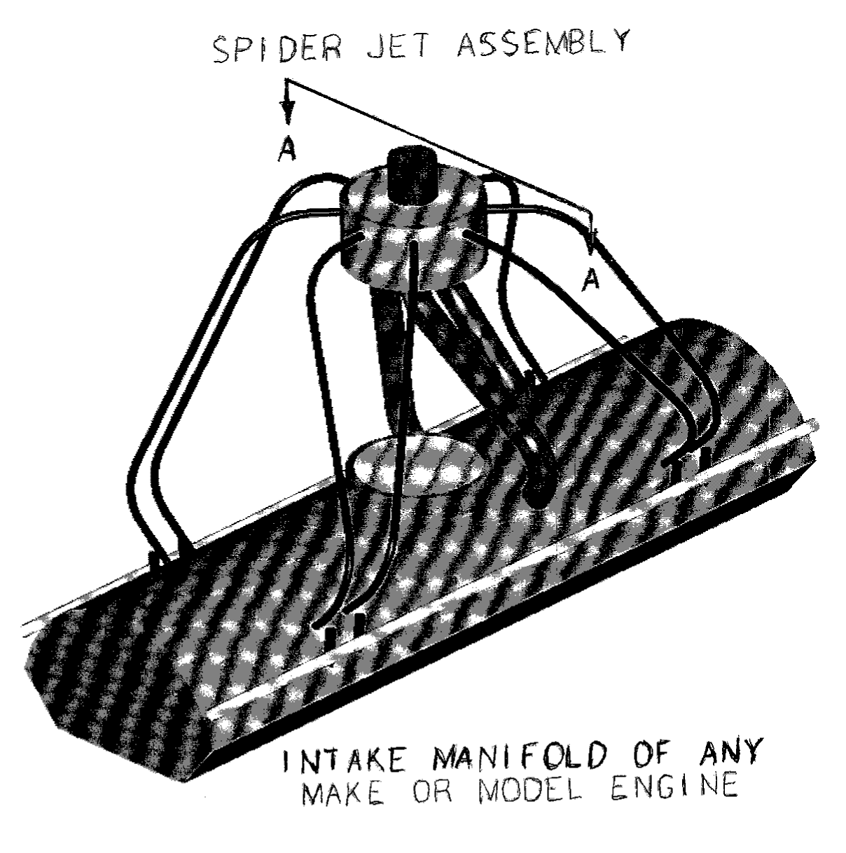

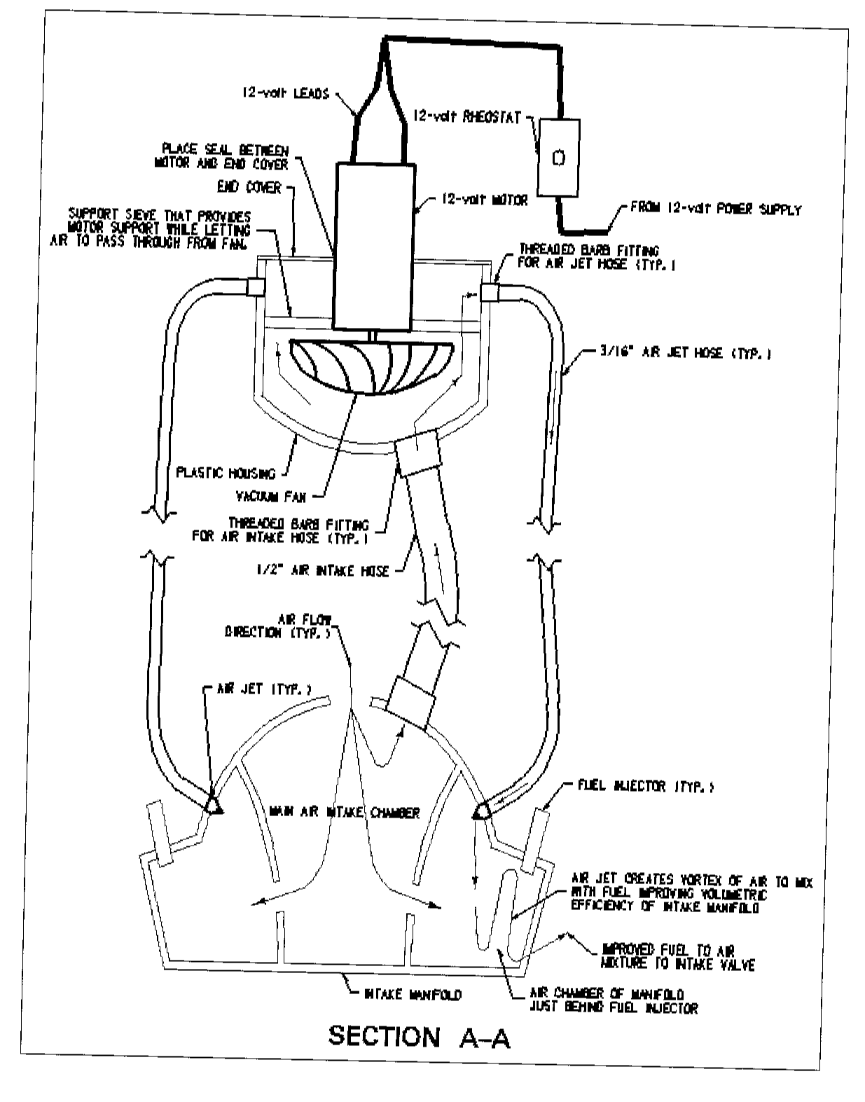

### BACKGROUND OF INVENTION

The Spider Jet was developed for use in the automotive industry. More specifically, to improve the volumetric efficiency of intake manifolds on the internal combustion engine. To understand the background of this invention, one must understand the reasons for the development of the modern fuel-injection system. For many decades the internal combustion engine was fed its fuel and air mixture by first, mixing the two components in a carburetion device and then distributing the mixture to the individual cylinders through an intake manifold. There were many adaptations and devices constructed to try and improve the horsepower and efficiency of this system. The one overriding problem with the carbureted fuel intake system was its inability to equally disperse fuel to all the cylinders of the engine. The development of the fuel rail and fuel injection system solved this problem. With this system, a fuel injector is placed near each intake valve and each cylinder is supplied the exact same amount of fuel as the other cylinders. The result was improved horsepower and, in some models of engine, improved efficiency. Two other major developments led to the widely accepted use of the fuel-injection system. Those developments were the improvement and compact size of the modern computer and the use of oxygen sensors in the exhaust stream. These two items allow the fuel rail-injection system to quickly adjust the amount of fuel injected into the manifold, based on the amount of oxygen present in the exhaust of the engine. Oxygen sensors in the exhaust stream of the engine determine the amount of oxygen present in the exhaust gases and then the on-board computer makes adjustments to the amount of fuel at the injectors based on a pre-programmed list of criteria in the computer. All of these things combined, have led to today's modern engines, which have adequate horsepower and meet stringent emission controls. But all the development has over-looked one major problem, the fuel efficiency of the intake manifold. In the older carbureted engines, the air and fuel were constantly mixing from the time they were introduced in the carburetor (usually situated on top of the intake manifold) until the mixture was let into the cylinder by the intake valve. This distance, depending on model, could be up to twenty inches. In the fuel injection system the distance for the fuel and air to mix together, in most cases, is less than three inches. So the problems of both types of fuel delivery are apparent. The older carbureted engines did not distribute fuel and air equally and thus had reduced horsepower but the longer mixing chambers of the intake manifold made the system fairly fuel efficient. The newer fuel-injected engines do not allow the fuel and air enough time to mix properly and thus have reduced efficiency but because a large amount of fuel is injected into the cylinders, the engines deliver consistent and increased horsepower. The solution to both problems can be found in a single device and design that can be added on to any engine.

### SUMMARY OF INVENTION

The Spider Jet is a vacuum device that pulls air or the air-fuel mixture from the main intake chamber of the intake manifold and delivers it more efficiently to the intake valve. The main intake chamber is directly under the throttle body or carburetor assembly depending on what type of fuel system is in use. The Spider Jet then redirects and compresses the air into smaller hoses. The air or air-fuel mixture is then forced back into the intake manifold above the intake valve through an air jet. The forced air then creates a vortex of air and/or air-fuel at the intake valve and thus provides the fuel and air additional mixing time. In carbureted engines, the Spider jet equalizes the fuel distribution to the cylinders located furthest from the carburetor and in fuel-injection systems, the Spider jet improves the volumetric efficiency of the intake manifold.

### BRIEF DESCRIPTION OF DRAWINGS

Drawing #1: An isometric drawing of the complete assembly with a simulated version of only one type of intake manifold. This drawing indicates the cross section location for the set up of the next drawing.

Drawing #2: Section A-A of the previous drawing. The drawing indicates how the Spider Jet pulls air or air-fuel mixture from one portion of the intake manifold and relocates it in compressed form to the air chamber directly above each cylinder.

### DETAILED DESCRIPTION

The Spider Jet device solves the weak horsepower problem of older carbureted engines and the poor fuel efficiency problems of the modern fuel-rail and injectors delivery system. It does this by equally distributing fuel and air to all cylinders in the older engines and by improving the volumetric efficiency in the newer models intake manifolds. The device is constructed using a simple 12-volt vacuum device. These can be purchased as a 12-volt hand held vacuum cleaner usually advertised as car vacuums that can plug into the cigarette lighter outlet in the passenger compartment of automobiles. Once purchased the motor, vacuum fan, and cord can be easily disassembled from the proprietary housing. A 3-inch poly-vinyl chloride (PVC) end cap or similar sized plastic housing that will accommodate the vacuum fan is used to provide the main body of the device. Depending on the size of the engine, the size of the vacuum fan, intake hoses, jet hoses, and air jets may need to be larger or smaller than the sizes described here. Also, any type of 12-volt vacuum device would suffice, especially one that is already set up as a wet-dry vacuum combination. The main concern is that the electrical motor of the vacuum must be sealed away from the air and air-fuel mixture to avoid combustion. The drawing indicates three one-half inch flexible intake hoses to be used to provide the intake to the Spider Jet. A total of six barbed fittings and pipe clamps will be necessary to hold the hoses in place. Three holes that will allow the fittings of the intake hoses are drilled into the Spider Jet housing and the intake manifold. Careful measurement should be made to ensure that three holes on the manifold and the Jet are equally spaced from each other, but are in locations that will allow air to freely enter from the manifold and be pulled into the Jet. Each of the six holes should be reamed with a threading tap to accommodate the barb fittings. Next determine the number of jet hoses needed for the engine. The number of jet hoses will equal the number of cylinders in the engine. The drawings indicate a standard V8 engine (8 cylinders arranged in a V pattern), so there are 8 jet hoses exiting from the Spider Jet. The Spider jet can be built to accommodate any number of cylinders or intake manifold design. The drawings also indicate how the name of this device was derived. On a V8 engine, the Spider Jet assembly and jet hoses resemble a large spider standing atop the manifold. Eight barbed fittings and pipe clamps will be needed to attach the ⅜-inch air jet hoses to the Spider Jet. Eight holes will need to be drilled into the PVC housing of the Jet, again, carefully measured so that all eight holes are equally spaced from each other. All eight holes should be reamed with the appropriate threading tap to allow the barbed fittings to be screwed and secured into the Jet. Eight holes will need to be drilled into the intake manifold as near the fuel injector as possible but in locations that will allow the hose to be secured to each individual air jet and still clear the fuel rail and injector assembly. Some research and again careful measuring should be undertaken to ensure the ease of installation of the air jets into the manifold. Once location is determined, the size of the holes will need to be assessed. A common and cheap method of jetting the air back into the manifold is to use brake-bleeding valves. These small threaded valves were designed to allow the escape of air from the front disk brake fluid system of most automobiles but they also fit the needs of the Spider Jet in a cost effective manner. Determine the size of the threads on the brake bleeding valves, then drill and tap the pre-determined locations on the intake manifold. The air jet hoses can be secured to the brake valves with pipe clamps. The length of the air jet hoses should all be equal. Determine the length necessary to supply air to the furthest jet and measure that length of hose. Cut the remaining air jet hoses the same length. This will ensure that the air is equally distributed throughout the system. The vacuum fan and 12-volt motor assembly should be fitted with a solid end cover near the back of the motor and support sieve just behind the vacuum fan. The end cover will seal the air inside the Spider Jet and the support sieve allows air and/or air-fuel to pass but holds the motor and fan securely in place. One method of accomplishing this was using a plastic floor drain for a shower stall, trimmed to fit inside the 3-inch PVC cap and glued to the motor housing in the drawing. Finishing screws then secure the sieve to the 3-inch PVC. A 12-volt rheostat may be spliced into the leads of the 12-volt motor, so the Spider Jet vacuum speed may be adjusted, if necessary. The 12-volt rheostat can be purchased under the title of a 12-volt dimmer switch. The rheostat should be spliced near the cigarette lighter plug in, so that the driver, if necessary, can adjust both the power and speed of the Spider Jet. Once the assembly has been completed and installed onto the intake manifold, the Spider Jet will need to be secured to engine. Due to the various engine compartment sizes and shapes, the user may have some difficulty finding a location to secure the spider jet. Usually, using a large pipe clamp or plumbers tape with screws and bolts, duct tape and or any combination thereof, will adequately secure the Spider Jet to the engine so that it will not move even when driving over rough terrain. After installation and mounting of the Spider Jet, the engine will be ready to be tested. This is where the rheostat will be most beneficial. The newer modern engines equipped with a computer, oxygen sensors, and catalytic converters, will have a graph and pre-programmed list of criteria for various intake manifold volumetric efficiencies, built into the on-board computer system to automatically adjust the fuel rates depending on the amount of oxygen present in the exhaust stream. Most engines operate with fairly poor efficiency, so the speed of the Spider Jet can mostly likely be left wide open without exceeding the pre-programmed limits. However, in the unlikely case the Spider Jet provides too much air for the pre-programmed computer to adjust to, the engine will run roughly and not sound smooth. In this case simply adjust the speed of the Spider Jet down using the rheostat in the passenger compartment until the engine is running smoothly again. The Spider Jet works by taking air or air-fuel mixture that has already been introduced into the intake manifold and redirects to a location that it will be much more beneficial. The Spider Jet is successful because the air removed from the system is nearly equal to the air that is in demand at the intake of the cylinder. Any additional negative pressures inside the intake manifold created by the Spider Jet would be offset by their re-introduction at the intake. Also if the negative pressures inside the manifold escalate, the only consequence is that additional air enters the system from the throttle body or carburetor. Some would argue that the fuel to air mixture would be too lean with this device (More than optimum air to fuel), but the fact of the matter is the Spider Jet is not bringing in more air, it is simply providing more opportunity for the fuel and air to mix together properly. This improves the volumetric efficiency of the intake manifold. Because the on-board computers are pre-programmed with various fuel demands for different engine designs, the Spider Jet does not require any modification to the engine other than those to install the device.

1. I claim that an air redistribution system like the Spider Jet mounted on the intake manifold of an internal combustion engine will improve horsepower and fuel efficiency on older carbureted fuel delivery engine and will also improve horsepower fuel efficiency on new fuel rail and injector delivery systems. Preliminary tests indicate the Spider Jet can double the fuel efficiency of most internal combustion engines.
